(19) United States
(12) Patent Application Publication
(10) Pub. No.: US 2026/0104515 A1
(43) Pub. Date: Apr. 16, 2026

(54) SYSTEM, METHOD AND COMPUTER PROGRAM PRODUCT FOR IMPROVED GNSS CONTROL

(71) Applicant: ISRAEL AEROSPACE INDUSTRIES LTD., Lod (IL)

(72) Inventor: Maayan HONIG, Tel Aviv (IL)

(21) Appl. No.: 19/116,073

(22) PCT Filed: Sep. 12, 2023
(86) PCT No.: PCT/IL2023/050982

§ 371 Date: Mar. 27, 2025

(30) Foreign Application Priority Data
Sep. 28, 2022 (IL) 296852

(51) Int. Cl. G01S 19/39; G01S 19/08

(52) U.S. Cl. CPC G01S 19/396; G01S 19/08

(57) ABSTRACT

Using a e.g. said hardware processor, comparing said estimate of current GNSS quality, for each vehicle in a fleet of interest to the client, to a GNSS quality target value, and, on at least one occasion in which a vehicle in the fleet of interest to the client is found to differ unacceptably from the GNSS quality target value, commanding an actuator to take at least one corrective measure,
thereby to yield GNSS quality monitoring functionality.

### FIELD OF THIS DISCLOSURE

The present invention relates generally to moving platforms, and more particularly to navigation.

### BACKGROUND

Examples of known GNSS systems are available here: https://www.gps.gov/systems/gnss/.

ADS-B: Automatic Dependent Surveillance-Broadcast is a known system that aircraft use to broadcast their own, GNSS-derived locations. Automatic Dependent Surveillance-Broadcast sensors receive these broadcasts.

Flightradar24 is an example of a site which derives aircraft locations from location broadcasts of aircraft & ships, which were originally provided for local use, e.g., in preventing crashes between aircraft and ships. A well-known system that large ships use to broadcast their locations is AIS aka Automatic Identification System. Collection, by satellites, of aircraft & ships' location broadcasts, originally provided for local use, e.g., in preventing crashes between aircraft and ships, is known.

The disclosures of all publications and patent documents mentioned in the specification, and of the publications and patent documents cited therein directly or indirectly, are hereby incorporated by reference, other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF CERTAIN EMBODIMENTS

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate.

Certain embodiments seek to improve functioning of platforms whose operation is at least partly GNSS-based e.g., because their navigation is GNSS-controlled.

Certain embodiments seek to provide GNSS control and/or monitoring by comparing reported locations, e.g. of platforms within communication range, with actual locations of same.

It is appreciated that any reference herein to, or recitation of, an operation being performed is, e.g. if the operation is performed at least partly in software, intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P, may not, itself, perform all of the operations, and, instead, the remote processor P itself may receive output/s of portion/s of the operations from yet another processor/s P′, may be deployed off-shore relative to P, or “on a cloud”, and so forth.

The present invention typically includes at least the following embodiments:

Embodiment 1. A system for improving GNSS-based functioning of platforms, the system including:
a hardware processor which typically provides, to a client, an estimate of current GNSS quality e.g. at a location occupied by a given platform, typically by, at least once, computing increasing functions of distances e.g. between GNSS-based estimated locations of the given platform, and/or locations estimated independently of the GNSS, for the given platform; and
a hardware processor which compares the estimate of current GNSS quality, typically for each vehicle in a fleet of interest to the client, e.g. to a GNSS quality target value, and, on at least one occasion in which a vehicle e.g. in the fleet of interest to the client is found to differ unacceptably from the GNSS quality target value, commands an actuator to take at least one corrective measure, thereby to yield GNSS quality monitoring functionality.

It is appreciated that a fleet or vehicle therein may be of interest due to its identity and/or due to its position.

Embodiment 2. A system according to any of the preceding embodiments wherein the estimate of current GNSS quality at a location occupied by a given platform is transmitted to the client.

Embodiment 3. A system according to any of the preceding embodiments wherein the platform comprises a ground vehicle.

Embodiment 4. A system according to any of the preceding embodiments wherein the platform is airborne.

Embodiment 5. A system according to any of the preceding embodiments wherein the platform is seaborne.

Embodiment 6. A system according to any of the preceding embodiments wherein the locations estimated independently of the GNSS are estimated by a radar system.

Embodiment 7. A system according to any of the preceding embodiments wherein the GNSS comprises GPS.

Embodiment 8. A system according to any of the preceding embodiments wherein the corrective measure comprises generating an alert.

Embodiment 9. A system according to any of the preceding embodiments wherein the acatuator comprises hardware which alleviates risks generated by poor quality GNSS.

Embodiment 10. A computer program product, comprising a non-transitory tangible computer readable medium having computer readable program code embodied therein, the computer readable program code adapted to be executed to implement a method for improving GNSS-based functioning of platforms, the method including: Using a hardware processor to provide, to a client, an estimate of current GNSS quality at a location occupied by a given platform, by, at least once, computing increasing functions of distances between GNSS-based estimated locations of the given platform, and locations estimated independently of the GNSS, for the given platform; and using a e.g. the hardware processor, comparing the estimate of current GNSS quality, for each vehicle in a fleet of interest to the client, to a GNSS quality target value, and, on at least one occasion in which a vehicle in the fleet of interest to the client is found to differ unacceptably from the GNSS quality target value, commanding an actuator to take at least one corrective measure, thereby to yield GNSS quality monitoring functionality.

Embodiment 11. A method for improving GNSS-based functioning of platforms, the method including:
Using a hardware processor to provide, to a client, an estimate of current GNSS quality at a location occupied by a given platform, by, at least once, computing increasing functions of distances between GNSS-based estimated locations of the given platform, and locations estimated independently of the GNSS, for the given platform; and
Using a e.g. the hardware processor, comparing the estimate of current GNSS quality, for each vehicle in a fleet of interest to the client, to a GNSS quality target value, and, on at least one occasion in which a vehicle in the fleet of interest to the client is found to differ unacceptably from the GNSS quality target value, commanding an actuator to take at least one corrective measure, thereby to yield GNSS quality monitoring functionality.

Also provided, excluding signals, is a computer program comprising computer program code means for performing any of the methods shown and described herein when the program is run on at least one computer; and a computer program product, comprising a typically non-transitory computer-usable or-readable medium e.g. non-transitory computer-usable or-readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes, or a general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display, e.g., on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules illustrated and described herein may include any one or combination or plurality of: a server, a data processor, a memory/computer storage, a communication interface (wireless (e.g., BLE) or wired (e.g., USB)), and a computer program stored in memory/computer storage.

The term “process” as used above is intended to include any type of computation or manipulation or transformation of data represented as physical, e.g., electronic, phenomena which may occur or reside e.g., within registers and/or memories of at least one computer or processor. Use of nouns in singular form is not intended to be limiting; thus the term processor is intended to include a plurality of processing units which may be distributed or remote, the term server is intended to include plural typically interconnected modules running on plural respective servers, and so forth.

The above devices may communicate via any conventional wired or wireless digital communication means, e.g., via a wired or cellular telephone network, or a computer network such as the Internet.

The apparatus of the present invention may include, according to certain embodiments of the invention, machine readable memory containing or otherwise storing a program of instructions which, when executed by the machine, implements all or any subset of the apparatus, methods, features, and functionalities of the invention shown and described herein. Alternatively, or in addition, the apparatus of the present invention may include, according to certain embodiments of the invention, a program as above which may be written in any conventional programming language, and optionally a machine for executing the program, such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices or may be provided to external factors e.g. via a suitable data network. The term “computer” should be broadly construed to cover any kind of electronic device with data processing capabilities, including, by way of non-limiting example, personal computers, servers, embedded cores, computing system, communication devices, processors (e.g., digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g., chips, which may be co-located or remote from one another. Any controller or processor may, for example, comprise at least one CPU, DSP, FPGA or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs), or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably, e.g., a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein, and/or to perform functionalities described herein, and/or to implement any engine, interface or other system illustrated or described herein. Any suitable computerized data storage e.g., computer memory, may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s e.g. as described herein which may, for example, include all or any subset of: an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof, and back-end logic interacting therewith. Thus, the term user interface or “UI” as used herein, includes also the underlying logic which controls the data presented to the user e.g., by the system display, and receives and processes and/or provides to other modules herein, data entered by a user e.g., using her or his workstation/device.

### BRIEF DESCRIPTION OF THE DRAWINGS

Example embodiments are illustrated in drawings. Specifically, arrows between modules may be implemented as APIs and any suitable technology may be used for interconnecting functional components or modules illustrated herein in a suitable sequence or order e.g., via a suitable API/Interface. For example, state of the art tools may be employed, such as but not limited to Apache Thrift and Avro which provide remote call support. Or, a standard communication protocol may be employed, such as but not limited to HTTP or MQTT, and may be combined with a standard data format, such as but not limited to JSON or XML. According to one embodiment, one of the modules may share a secure API with another. Communication between modules may comply with any customized protocol or customized query language, or may comply with any conventional query language or protocol.

FIG. 1 is a simplified flowchart illustration of a control method according to certain embodiments. The method of FIG. 1 typically comprises all or any subset of the illustrated operations, suitably ordered e.g., as shown.

Methods and systems included in the scope of the present invention may include any subset or all of the functional blocks shown in the specifically illustrated implementations by way of example, in any suitable order e.g. as shown. Flows may include all or any subset of the illustrated operations, suitably ordered e.g., as shown. Tables herein may include all or any subset of the fields and/or records and/or cells and/or rows and/or columns described.

Computational, functional or logical components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences, such as but not limited to objects, procedures, functions, routines and programs, and may originate from several computer files which typically operate synergistically.

Each functionality or method herein may be implemented in software (e.g. for execution on suitable processing hardware such as a microprocessor or digital signal processor), firmware, hardware (using any conventional hardware technology such as Integrated Circuit Technology), or any combination thereof.

Functionality or operations stipulated as being software-implemented may, alternatively, be wholly or fully implemented by an equivalent hardware or firmware module, and vice-versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware, in which case all or any subset of the variables, parameters, and computations described herein may be in hardware.

Any module or functionality described herein may comprise a suitably configured hardware component or circuitry. Alternatively or in addition, modules or functionality described herein may be performed by a general purpose computer, or more generally, by a suitable microprocessor, configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option such as but not limited to FPGA, ASIC or DSP or any suitable combination thereof.

Any hardware component mentioned herein may in fact include either one or more hardware devices e.g. chips, which may be co-located or remote from one another.

Any method described herein is intended to include, within the scope of the embodiments of the present invention, also any software or computer program performing all or any subset of the method's operations, including a mobile application, platform or operating system e.g. as stored in a medium, as well as combining the computer program with a hardware device to perform all or any subset of the operations of the method.

Data can be stored on one or more tangible or intangible computer readable media stored at one or more different locations, different network nodes, or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies, such as semiconductor, magnetic, optical, paper and others.

### DETAILED DESCRIPTION OF CERTAIN EMBODIMENTS

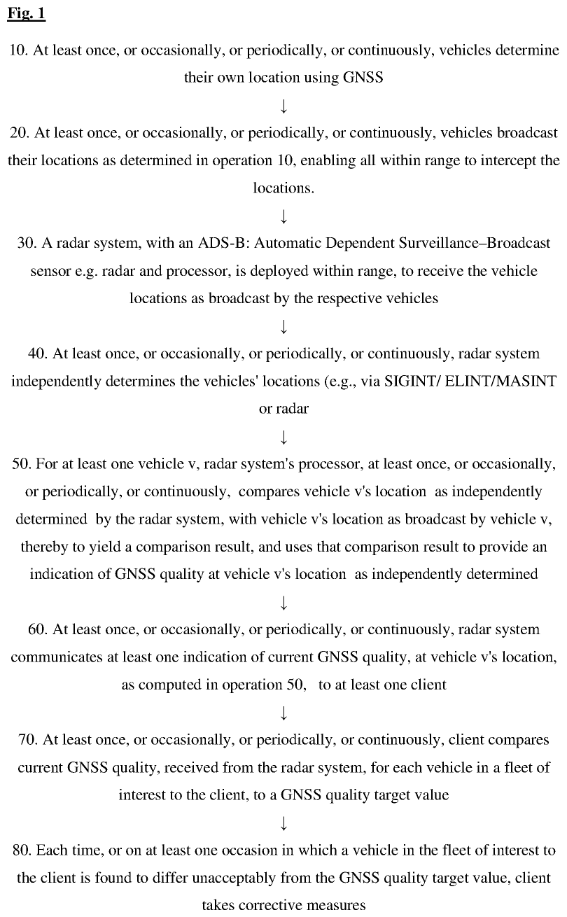

The following, e.g. as shown in FIG. 1, is a flow of a method for ensuring that GNSS quality is maintained thereby to improve functioning of platforms whose operation quality is affected by GNSS quality e.g., because their navigation is GNSS-controlled.

The method includes all or any subset of the following operations, suitably ordered e.g. as shown:

Operation 10. At least once, or occasionally, or periodically, or continuously, vehicles determine their own location using GPS or any other GNSS, either because they are required to advertise their locations, e.g., as a safety measure, or because they are cooperative vehicles configured to interact with, and serve, the system shown and described herein.

Operation 20. At least once, or occasionally, or periodically, or continuously, vehicles (or, more generally, platforms) broadcast their locations as determined in operation 10, enabling all within range to intercept the locations.

Operation 30. A receiver (sensor) e.g. radar that is able to receive signals broadcasts in operation 20, is deployed within range, to receive the vehicle locations as broadcast by the respective vehicles. The receiver may, by way of non-limiting example, be part of a radar system, with an ADS-B: Automatic Dependent Surveillance-Broadcast sensor and processor.

Operation 40. At least once or occasionally or periodically or continuously, system independently determines the vehicles' locations (e.g. via any standard method or combination of SIGINT/ELINT/MASINT, radar or optical triangulation), which may generically be termed “radar” system even when using some localizing method other than radar. This may or may not be collocated with the sensors (e.g. as per operation 30).

SIGINT aka signal intelligence, includes receiving signals a target sends out, and accordingly (typically through triangulation), locating the target. It is appreciated that plural e.g., 3 radars or other sensors, which, rather than being co-located, are deployed some distance apart, can be used to triangulate where a signal is coming from. Possibly the location signal (e.g. as in operation 20) may be used to triangulate the location (rather than the data included in the signal)

Operation 50. For at least one vehicle v, radar system's processor, at least once, or occasionally, or periodically, or continuously, compares vehicle v's location as independently determined by the radar system, with vehicle v's location as broadcast by vehicle v, thereby to yield a comparison result, and uses that comparison result to provide an indication of GNSS quality at vehicle v's location as independently determined; the indication may be an increasing function of a difference between vehicle v's location as broadcast and as independently determined. “Radar” used here is referencing any remote localization method and may or may not bethe actual technology employed.

Operation 60. At least once, or occasionally, or periodically, or continuously, radar system communicates. at least one indication of current GNSS quality, at vehicle v's location, as computed in operation 50, to at least one client.

Operation 70. At least once, or occasionally, or periodically, or continuously, client compares current GNSS quality, received from the radar system, for each vehicle in a fleet of interest, to the client, to a GNSS quality target value.

Operation 80. Each time, or on at least one occasion in which a vehicle in the fleet of interest to the client is found to differ unacceptably from the GNSS quality target value, client takes corrective measures.

### EXAMPLES

a. client=e.g., air-traffic controller and/or airport admin which seeks to ensure that, for all aircraft, current GNSS quality always exceeds a GNSS quality target value (aka minimal GNSS quality to guarantee safety). Each time a current GNSS quality drops below the minimal GNSS quality needed to guarantee safety, the client takes corrective measures (e.g., increases separation between aircraft and/or deploys/activates/assigns additional systems such as additional radars which are configured to de-conflict the aircrafts' paths).

b. client=facility (such as a correctional facility, detection facility, or any venue under threat) which uses Jammers to prevent drone over-flight. Anti-drone jammers are available, for example, here: https://www.skylock1.com/anti-drone-jammers/

Facility takes corrective measures to verify that the facility's jammers are not adversely affecting a local airport; it is appreciated that aircraft may be flying as low as 300 or 200 meters from the ground, in areas which are close to the airport.

Jammers mentioned herein may, for example, refer to RF jammers. Alternatively, the facility takes corrective measures to verify that the facility's jammers are effectively neutralizing drones.

Still with reference to operation 80, according to certain embodiments, the vehicle's current GNSS quality may be subtracted from the GNSS quality target value yielding scalar which may be compared to a threshold. Alternatively, or in addition, the system may take corrective measures if a vehicle has a sequence of GNSS qualities which appear to, over time, be tending, to an unacceptable degree, away from the GNSS quality target value. For example, if a trend is detected, whereby the GNSS qualities are drifting at least p% per day away from the GNSS quality target value, corrective measures may be employed. A threshold, determining whether or not to take corrective measures, may be applied to any derivative (first, second or higher) of a graph showing distance between vehicle's current GNSS quality and GNSS quality target value as a function of time. It is appreciated that terminology such as “mandatory”, “required”, “need” and “must” refer to implementation choices made within the context of a particular implementation or application described herewithin for clarity, and are not intended to be limiting, since, in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device, or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order, including simultaneous performance of suitable groups of operations, as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer-or machine-readable media.

Any computations or other forms of analysis described herein may be performed by a suitable computerized method. Any operation or functionality described herein may be wholly or partially computer-implemented e.g., by one or more processors. The invention shown and described herein may include (a) using a computerized method to identify a solution to any of the problems or for any of the objectives described herein, the solution optionally including at least one of a decision, an action, a product, a service or any other information described herein that impacts, in a positive manner, a problem or objectives described herein; and (b) outputting the solution.

The system may, if desired, be implemented as a network-e.g., web-based system employing software, computers, routers and telecommunications equipment as appropriate.

Any suitable deployment may be employed to provide functionalities, e.g., software functionalities shown and described herein. For example, a server may store certain applications, for downloading to clients, which are executed at the client side, the server side serving only as a storehouse. Any or all functionalities, e.g., software functionalities shown and described herein, may be deployed in a cloud environment. Clients, e.g., mobile communication devices such as smartphones, may be operatively associated with, but external to the cloud.

The scope of the present invention is not limited to structures and functions specifically described herein, and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false, and to perform y each time x is determined to be true, thereby to yield a processor which performs y at least once, typically on an “if and only if” basis e.g. triggered only by determinations that x is true, and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein to have capabilities to perform a technical operation responsive to the state or condition. The technical operation may for example comprise changing the state or condition, or may more generally cause any outcome which is technically advantageous given the state or condition or data, and/or may prevent at least one outcome which is disadvantageous, given the state or condition or data. Alternatively, or in addition, an alert may be provided to an appropriate human operator or to an appropriate external system.

Features of the present invention, including operations, which are described in the context of separate embodiments, may also be provided in combination in a single embodiment. For example, a system embodiment is intended to include a corresponding process embodiment, and vice versa. Also, each system embodiment is intended to include a server-centered “view” or client centered “view”, or “view” from any other node of the system, of the entire functionality of the system, computer-readable medium, or apparatus, including only those functionalities performed at that server or client or node. Features may also be combined with features known in the art and particularly, although not limited to, those described in the Background section, or in publications mentioned therein.

Conversely, features of the invention, including operations, which are described for brevity in the context of a single embodiment or in a certain order, may be provided separately or in any suitable sub-combination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered e.g. as illustrated or described herein.

Devices, apparatus or systems shown coupled in any of the drawings may in fact be integrated into a single platform in certain embodiments, or may be coupled via any appropriate wired or wireless coupling, such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation, and is not intended to be limiting.

Any suitable communication may be employed between separate units herein e.g. wired data communication and/or in short-range radio communication with sensors such as cameras, e.g. via Wifi, Bluetooth, or Zigbee.

It is appreciated that implementation via a cellular app as described herein is but an example, and, instead, embodiments of the present invention may be implemented, say, as a smartphone SDK; as a hardware component; as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network, or is tethered directly or indirectly/ultimately to such a node).

Any operation or characteristic described herein may be performed by another actor outside the scope of the patent application and the description is intended to include apparatus whether hardware, firmware, or software, which is configured to perform, enable, or facilitate that operation, or to enable, facilitate, or provide that characteristic.

The terms processor, or controller, or module, or logic, as used herein, are intended to include hardware such as computer microprocessors, or hardware processors, which typically have digital memory and processing capacity, such as those available from, say Intel and Advanced Micro Devices (AMD). Any operation or functionality or computation or logic described herein may be implemented entirely or in any part on any suitable circuitry, including any such computer microprocessor/s, as well as in firmware, or in hardware, or any combination thereof.

It is appreciated that elements illustrated in more than one drawings, and/or elements in the written description may still be combined into a single embodiment, except if otherwise specifically clarified herewithin. Any of the systems shown and described herein may be used to implement or may be combined with, any of the operations or methods shown and described herein.

It is appreciated that any features, properties, logic, modules, blocks, operations or functionalities described herein which are, for clarity, described in the context of separate embodiments, may also be provided in combination in a single embodiment, except where the specification or general knowledge specifically indicates that certain teachings are mutually contradictory and cannot be combined. Any of the systems shown and described herein may be used to implement, or may be combined with, any of the operations or methods shown and described herein.

Conversely, any modules, blocks, operations or functionalities described herein, which are, for brevity, described in the context of a single embodiment, may also be provided separately, or in any suitable sub-combination, including with features known in the art. Each element e.g., operation described herein may have all characteristics and attributes described or illustrated herein, or, according to other embodiments, may have any subset of the characteristics or attributes described herein.

It is appreciated that any features, properties, logic, modules, blocks, operations or functionalities described herein which are, for clarity, described in the context of a single independent system, may also be a system that covers large geographical areas e, g, the territory of a country, or a barrier built out of multiple sets of hardware with single or multiple independent logic or computations and relevant management systems. Examples of systems which may implement all or any subset of the operations of FIG. 1 may include any suitable radar system with a ads-b sensor, such as, for example: https://www.iai.co.il/elta-systems-introduces-next-generation-multi-sensor-elm-2084-mmr-radar or any suitable jammer which may seek to verify that its operation is not impacting traffic such as, for example: https://www.iai.co.il/p/eli-4030-drone-guard-esm

It is appreciated that performing all or any subset of the operations of FIG. 1 yields an improvement relative to the known operations of systems such as AIS (for sea) or ADS-B or TCAS, in the air.

The term GNSS-Global Navigation Satellite System-as used herein is intended to include any system, e.g. satellite system, that provides positioning and/or navigation and/or timing data, whether locally, regionally or globally, typically as a service, to platforms which typically move via land, sea, air, or space. GPS is one example of a GNSS.

1. A system for improving GNSS-based functioning of platforms, the system including:
a hardware processor which provides, to a client, an estimate of current GNSS quality at a location occupied by a given platform, by, at least once, computing increasing functions of distances between GNSS-based estimated locations of the given platform, and locations estimated independently of the GNSS, for said given platform; and
a hardware processor which compares said estimate of current GNSS quality, for each vehicle in a fleet of interest to the client, to a GNSS quality target value, and, on at least one occasion in which a vehicle in the fleet of interest to the client is found to differ unacceptably from the GNSS quality target value, commands an actuator to take at least one corrective measure,
thereby to yield GNSS quality monitoring functionality.

2. A system according to claim 1 wherein said estimate of current GNSS quality at a location occupied by a given platform is transmitted to the client.

3. A system according to claim 1 wherein said platform comprises a ground vehicle.

4. A system according to claim 1 wherein said platform is airborne.

5. A system according to claim 1 wherein said platform is seaborne.

6. A system according to claim 1 wherein said locations estimated independently of the GNSS are estimated by a radar system.

7. A system according to claim 1 wherein said GNSS comprises GPS.

8. A system according to claim 1 wherein said corrective measure comprises generating an alert.

9. A system according to claim 1 wherein said acatuator comprises hardware which alleviates risks generated by poor quality GNSS.

10. A computer program product, comprising a non-transitory tangible computer readable medium having computer readable program code embodied therein, said computer readable program code adapted to be executed to implement a method for improving GNSS-based functioning of platforms, the method including:
Using a hardware processor to provide, to a client, an estimate of current GNSS quality at a location occupied by a given platform, by, at least once, computing increasing functions of distances between GNSS-based estimated locations of the given platform, and locations estimated independently of the GNSS, for said given platform; and
Using a hardware processor, comparing said estimate of current GNSS quality, for each vehicle in a fleet of interest to the client, to a GNSS quality target value, and, on at least one occasion in which a vehicle in the fleet of interest to the client is found to differ unacceptably from the GNSS quality target value, commanding an actuator to take at least one corrective measure,
thereby to yield GNSS quality monitoring functionality.

11. A method for improving GNSS-based functioning of platforms, the method including:
Using a hardware processor to provide, to a client, an estimate of current GNSS quality at a location occupied by a given platform, by, at least once, computing increasing functions of distances between GNSS-based estimated locations of the given platform, and locations estimated independently of the GNSS, for said given platform; and
